(19) United States
(12) Patent Application Publication
(10) Pub. No.: US 2020/0410413 A1
(43) Pub. Date: Dec. 31, 2020

(54) DATA PROCESSING APPARATUS, DATA PROCESSING METHOD, AND RECORDING MEDIUM

(71) Applicant: TOKYO ELECTRON LIMITED, Tokyo (JP)

(72) Inventors: Hironori MOKI, Sapporo City (JP); Takahiko KATO, Miyagi (JP)

(21) Appl. No.: 16/911,862

(22) Filed: Jun. 25, 2020

(30) Foreign Application Priority Data
Jun. 27, 2019 (JP) 2019-120365

(51) Int. Cl. G06Q 10/06; G05B 19/4155

(52) U.S. Cl. CPC G06Q 10/0633; G05B 2219/45031; G05B 19/4155

(57) ABSTRACT

A data processing apparatus includes: a first storage part that stores an analysis result that specifies each region when a feature space is divided such that a distribution of each data group associated with a predetermined step of a manufacturing process in the space is classified according to an effect calculated for each data group in the predetermined step; a second storage part that stores models each of which outputs the effect corresponding to each region, in association with each region, when the data groups classified into each region of the feature space are inputted; and an execution part for performing a simulation processing by using, among the models, a model stored in association with one region when a new data group associated with the predetermined step is acquired and when the one region into which the acquired new data group is classified is determined based on the analysis result.

### CROSS-REFERENCE TO RELATED APPLICATION

This application is based upon and claims the benefit of priority from Japanese Patent Application No. 2019-120365, filed on Jun. 27, 2019, the entire contents of which are incorporated herein by reference.

### TECHNICAL FIELD

The present disclosure relates to a data processing apparatus, a data processing method, and a non-transitory computer-readable recording medium storing a program therefor.

### BACKGROUND

A data processing apparatus which performs various analyses by collecting data used or measured in a manufacturing process (for example, a semiconductor manufacturing process) has been conventionally known. By using such a data processing apparatus, the collected data is analyzed to generate a model so that a simulation processing of the manufacturing process may be performed.

### PRIOR ART DOCUMENTS

### Patent Documents

Patent Document 1: Specification of U.S. Patent Application Publication No. 2017/0177997
Patent Document 2: Specification of U.S. Patent Application Publication No. 2015/0211122
Patent Document 3: Japanese Laid-Open Patent Publication No. 2009-152269

### SUMMARY

According to one embodiment of the present disclosure, there is provided a data processing apparatus including: a first storage part that stores an analysis result that specifies each of a plurality of regions of a feature space when the feature space is divided such that a distribution of each of a plurality of data groups associated with a predetermined step of a manufacturing process in the feature space is classified according to an effect calculated for each of the plurality of data groups in the predetermined step; a second storage part that stores a plurality of models each of which outputs the effect corresponding to each of the plurality of regions, in association with each of the plurality of regions, when the plurality of data groups classified into each of the plurality of regions of the feature space are inputted; and an execution part configured to perform a simulation processing by using, among the plurality of models, a model stored in association with one region when a new data group associated with the predetermined step is acquired and when the one region into which the acquired new data group is classified is determined based on the analysis result.

### BRIEF DESCRIPTION OF DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a view illustrating an exemplary overall configuration of a data processing system.

FIG. 2 is a view illustrating a specific example of a data group handled by each business office.

FIG. 3 is a view for explaining an outline of analysis result data stored in an analysis result storage part.

FIG. 4 is a view illustrating an exemplary hardware configuration of a data processing device.

FIG. 5 is a view illustrating an exemplary functional configuration of a data analysis part.

FIG. 6 is a view illustrating a specific example of processing performed by an effect calculation part.

FIG. 7 is a view illustrating an exemplary data group stored in the data storage part.

FIG. 8 is a view illustrating a specific example of processing performed by a division part.

FIG. 9 is a view illustrating an example of Proxel calculated by a Proxel calculation part.

FIG. 10 is a first flowchart illustrating a flow of a Proxel calculation processing performed by the division part and the Proxel calculation part.

FIG. 11 is a first view for explaining advantages in Proxel calculation.

FIG. 12 is a second view for explaining advantages in Proxel calculation.

FIG. 13 is a view illustrating an example of a functional configuration of a model generation part.

FIG. 14 is a first view illustrating a specific example of processing performed by the model generation part.

FIG. 15 is a second view illustrating a specific example of processing performed by the model generation part.

FIG. 16 is a first flowchart illustrating a flow of a model generating process performed by the model generation part.

FIG. 17 is a view illustrating an example of a functional configuration of an estimation part.

FIG. 18 is a view illustrating a specific example of processing performed by the estimation part.

FIG. 19 is a flowchart illustrating a flow of an estimating process performed by the estimation part.

FIG. 20 is a view illustrating an example of simulation accuracy in each model per Proxel.

### DETAILED DESCRIPTION

Hereinafter, various embodiments will be described with reference to the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments. In the present specification and drawings, constitutional elements having substantially the same functional configurations will be denoted by the same numeral references, and redundant descriptions thereof will be omitted.

### First Embodiment

### <Overall Configuration of Data Processing System>

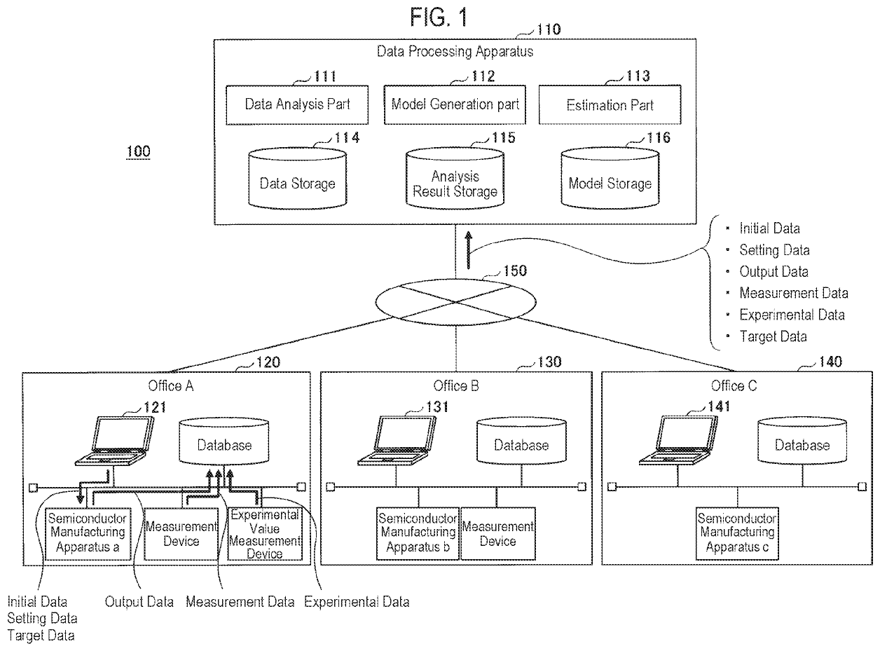

First, the overall configuration of a data processing system will be described. FIG. 1 is a view illustrating an exemplary overall configuration of the data processing system. As illustrated in FIG. 1, a data processing system 100 includes a data processing apparatus 110 and terminals 121, 131, and 141 provided in respective business offices 120, 130, and 140 (office names=“Business Office A”. “Business Office B”, and “Business Office C”). The data processing apparatus 110 and the terminals 121, 131, and 141 provided in the respective business offices 120, 130, and 140 are connected to each other in a communicable relationship with each other via a network 150.

A data analysis program, a model generation program, and estimation program are installed on the data processing apparatus 110. When the data analysis program, the model generation program, and the estimation program are executed, the data processing apparatus 110 functions as a data analysis part 111, a model generation part 112, and an estimation part 113.

The data analysis part 111 collects data groups (in the example of FIG. 1, initial data, setting data, output data, measurement data, experimental data, and target data) from the terminals 121, 131, and 141 of the respective business offices 120, 130, and 140 via the network 150. In addition, the data analysis part 111 stores the collected data groups in a data storage part 114. The method of collecting data groups is not limited thereto. For example, an administrator of the data processing apparatus 110 may acquire a recording medium on which data groups are recorded from each of the business offices 120, 130, and 140, and may collect the data groups by reading the data groups from the recording medium.

The data analysis part 111 analyzes the data groups stored in the data storage part 114, and stores analysis result data in an analysis result storage part 115 (a first storage part).

The model generation part 112 classifies the data groups stored in the data storage part 114 based on the analysis result data, and generates a model of a semiconductor manufacturing process (for example, a semiconductor manufacturing apparatus a) by using each of the data groups thus classified. The model generation part 112 stores the generated model in a model storage part 116 (a second storage part).

When a new data group is acquired, the estimation part 113 performs a simulation processing by inputting the new data group into the model read from the model storage part 116.

The business office 120 (business office name=“Business Office A”) includes a semiconductor manufacturing apparatus that executes a semiconductor manufacturing process (the semiconductor manufacturing apparatus a). In addition, the business office 120 includes a measurement device configured to measure the measurement data in the semiconductor manufacturing process, and an experimental value measurement device configured to measure the experimental data on a resultant product (a semiconductor or an intermediate product) manufactured in the semiconductor manufacturing process. In addition, the business office 120 includes the terminal 121 constituting the data processing system 100 and a database that stores the data groups.

The semiconductor manufacturing apparatus a executes the semiconductor manufacturing process based on the initial data, the setting data, and the target data, which are inputted from the terminal 121. In addition, the semiconductor manufacturing apparatus a stores the output data obtained by executing the semiconductor manufacturing process in the database in association with the initial data, the setting data, and the target data.

The measurement device measures the measurement data during the execution of the semiconductor manufacturing process by the semiconductor manufacturing apparatus a, and stores the same in the database. The experimental value measurement device measures the experimental data on the resultant product (the semiconductor or the intermediate product) manufactured in the semiconductor manufacturing process, and stores the same in the database.

The terminal 121 inputs the initial data, the setting data, and the target data to be used when the semiconductor manufacturing apparatus a executes the semiconductor manufacturing process, and sets these data in the semiconductor manufacturing apparatus a. In addition, the terminal 121 transmits the data group (the initial data, the setting data, the output data, the measurement data, the experimental data, and the target data) stored in the database to the data processing apparatus 110.

A semiconductor manufacturing process similar to that of the business office 120 is executed in the business office 130 (business office name=“Business Office B”) and the business office 140 (business office name=“Business Office C”). To do this, each of the business office 130 and the business office 140 includes the same devices as those of the business office 120. However, in the example of FIG. 1, the business office 130 does not include the experimental value measurement device. In addition, the business office 140 does not include the measurement device and the experimental value measurement device.

As described above, in the case in which the devices included in the respective business offices are different from each other, the information items of the data groups transmitted from the respective terminals 121, 131, 141 of the respective business offices 120, 130, and 140 to the data processing apparatus 110 are also different from each other. For example, the data group transmitted from the terminal 131 of the business office 130 does not include experimental data (or a portion thereof). In addition, for example, the data group transmitted from the terminal 141 of the business office 140 does not include measurement data and experimental data (or a portion thereof).

### <Specific Example of the Data Group>

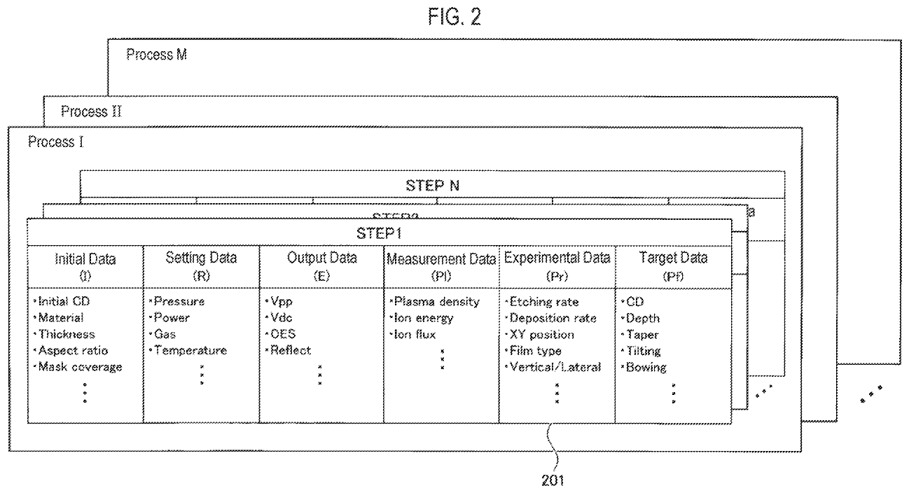

Next, the data groups handled by the respective business offices 120, 130 and 140 will be described. FIG. 2 is a view illustrating a specific example of the data group handled by each business office. Here, the data group handled by the business office 120 will be described.

As illustrated in FIG. 2, the semiconductor manufacturing apparatus a in the business office 120 executes a plurality of semiconductor manufacturing processes (process names=“PROCESSE I to PROCESS M”). Each of the semiconductor manufacturing processes executed by the semiconductor manufacturing apparatus a has a plurality of steps (for example step names=“STEP 1 to STEP N”). The “step” used herein refers to a minimum processing unit that changes a state (e.g., an attribute of a processing target, a state of the semiconductor manufacturing apparatus a, an internal atmosphere of the semiconductor manufacturing apparatus a or the like) in a semiconductor manufacturing process. Accordingly, in the case where the state changes with time, in the present embodiment, the steps before the lapse of time and after the lapse of time are regarded as separate steps.

In FIG. 2, a data group 201 is a data group associated with:
the semiconductor manufacturing process having the process name “PROCESS I”, among the plurality of semiconductor manufacturing processes executed by the semiconductor manufacturing apparatus a of the business office 120; and
the step having the step name “STEP 1”, among the plurality of steps included in the respective semiconductor manufacturing process.

As illustrated in FIG. 2, the data group 201 includes “Initial Data (I)”, “Setting Data (R)”, “Output Data (E)”, and “Measurement Data (Pl)”, “Experimental Data (Pr)”, and “Target Data (Pf)” as information items.

The “Initial data (I)” includes the initial data inputted from the terminal 121 of the business office 120. In the case of the semiconductor manufacturing process, the initial data includes, for example, the following:
Initial CD (critical dimension)
Material
Thickness
Aspect ratio
Mask coverage

The “Setting Data (R)” includes setting data inputted from the terminal 121 of the business office 120 and set in the semiconductor manufacturing apparatus a. The setting data set in the semiconductor manufacturing apparatus a is data depending on the characteristics of the semiconductor manufacturing apparatus a. In the case of the semiconductor manufacturing process, the setting data includes, for example, the following:
Pressure (internal pressure of chamber)
Power (power of high-frequency power supply)
Gas (gas flow rate)
Temperature (internal temperature of chamber or temperature on surface of processing target)

The “Output Data (E)” includes output data outputted from the semiconductor manufacturing apparatus a of the business office 120 during the execution of the step having the step name “STEP 1” of the semiconductor manufacturing process having the process name “PROCESS I” by the semiconductor manufacturing apparatus a of the business office 120. The output data outputted from the semiconductor manufacturing apparatus a is data that depends on the characteristics of the semiconductor manufacturing apparatus a. In the case of the semiconductor manufacturing process, the output data includes, for example, the following:
Vpp (potential difference)
Vdc (DC self-bias voltage)
OES (emission intensity by emission spectroscopy)
Reflect (reflected wave power)

The “Measurement Data (PI)” includes measurement data measured by the measurement device of the business office 120 during the execution of the step having the step name “STEP 1” of the semiconductor manufacturing process having the process name “PROCESS I” by the semiconductor manufacturing apparatus a of the business office 120. The measurement data measured by the measurement device is data that does not depend on the characteristics of the semiconductor manufacturing apparatus a. In the case of the semiconductor manufacturing process, the measurement data includes, for example, the following:
Plasma density
Ion energy
Ion flux (ion flow rate)

The “Experimental Data (Pr)” includes experimental data obtained by measuring, by the experimental value measurement device, a resultant product generated by executing the step having the step name “STEP 1” of the semiconductor manufacturing process having the process name “PROCESS I” by the semiconductor manufacturing apparatus a of the business office 120. The experimental data measured by the experimental value measurement device is data that does not depend on the characteristics of the semiconductor manufacturing apparatus a. In the case of the semiconductor manufacturing process, the experimental data includes, for example, the following:
Etching rate
Deposition rate (film formation rate)
XY position (XY coordinates)
Film type (type of thin film)
Vertical/lateral (vertical/lateral classification)

The “Target Data (P)” includes target data inputted from the terminal 121 of the business office 120. The target data is an attribute that a resultant product generated by executing the entire semiconductor manufacturing process having the process name “PROCESS 1” by the semiconductor manufacturing apparatus a of the business office 120, is to reach. In the case of the semiconductor manufacturing process, the target data includes, for example, the following:
CD (critical dimension)
Depth
Taper (taper angle)
Tilting (tilt angle)
Bowing

The data group illustrated in FIG. 2 is an exemplary data group, and the types of data included in each information item are not limited to the illustrated ones. It is assumed that a data group includes different information items and different types of data for each office, each process, and each step.

### <Outline of Analysis Result Data>

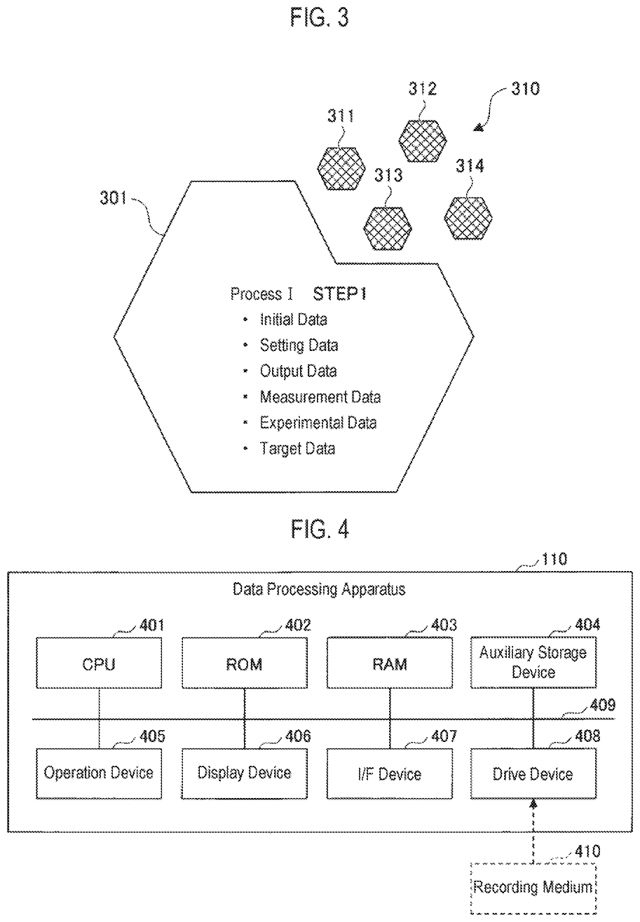

Next, an outline of the analysis result data stored in the analysis result storage part 115, which is obtained by analyzing the data groups collected from each of the business offices 120, 130, and 140 by the data analysis part 111 of the data processing apparatus 110, will be described. FIG. 3 is a view for explaining the outline of the analysis result data stored in the analysis result storage part.

In FIG. 3, a data group 301 is a data group associated with a step having the step name “STEP 1” of the semiconductor manufacturing process having the process name “PROCESS I”, and includes a plurality of data groups collected from each of the business offices 120, 130, and 140.

Specifically, the data group 301 includes data groups associated with the step having the step name “STEP 1” of the semiconductor manufacturing process having the process name “PROCESS I” of each of the business offices 130 and 140, in addition to the data group 201 collected from the business office 120.

The data processing apparatus 110 analyzes a plurality of data groups corresponding to the same step of the same process, and groups data groups that are capable of obtaining the same effect. This is because in the semiconductor manufacturing apparatus, even when the same step of the same process is performed, different results may be obtained due to different data included in the data groups. Therefore, the range of each data included in the data groups allowed in order to obtain the same effect may be calculated by grouping data groups that are capable of obtaining the same effect and calculating specific data that specifies each group.

In FIG. 3, a plurality of groups 310 are groups obtained by grouping data groups having the same effect in the data group 301. The specific data (each data range) specified by the groups in which the same effect is obtained in the same step of the same process may be regarded as a minimum data unit that gives a similar change in the “state” in the semiconductor manufacturing process. That is, the specific data (each data range) specified by the groups may be regarded as the smallest data unit in fine processing in the semiconductor manufacturing process.

As described above, the minimum data unit (process element) in the fine processing in the semiconductor manufacturing process is referred to as a “Proxel” in the first embodiment. This is the same name as the case where the minimum unit (picture element) of an image is called “Pixel” and the minimum unit of a three-dimensional structure (volume element) is called “Voxel”. Hereinafter, specific data pieces specified by the respective groups included in the plurality of groups 310 will be referred to as Proxels 311 to 314.

In the first embodiment, the data analysis part 111 calculates the “Proxel” by analyzing the collected data groups, and stores the calculated “Proxel” in the analysis result storage part 115 as analysis result data.

### <Hardware Configuration of Data Processing Device>

Next, a hardware configuration of the data processing apparatus 110 will be described. FIG. 4 is a diagram illustrating an example of the hardware configuration of the data processing apparatus 110.

As illustrated in FIG. 4, the data processing apparatus 110 includes a central processing unit (CPU) 401, a read only memory (ROM) 402, and a random access memory (RAM) 403. The CPU 401, the ROM 402, and the RAM 403 constitute a so-called computer. In addition, the data processing apparatus 110 includes an auxiliary storage device 404, an operation device 405, a display device 406, an interface (I/F) device 407, and a drive device 408. In addition, respective hardware components of the data processing apparatus 110 are connected to each other via a bus 409.

The CPU 401 executes various programs (e.g., the data analysis program, the model generation program, the estimation program and the like) installed on the auxiliary storage device 404.

The ROM 402 is a nonvolatile memory, and functions as a main storage device. The ROM 402 stores, for example, various programs and data necessary for the CPU 401 to execute various programs installed on the auxiliary storage device 404. Specifically, the ROM 402 stores, for example, a boot program such as a basic input/output system (BIOS), an extensible firmware interface (EFI) or the like.

The RAM 403 is volatile memory such as dynamic random-access memory (DRAM), static random-access memory (SRAM) or the like, and functions as a main storage device. The RAM 403 provides a work area to be expanded when various programs installed on the auxiliary storage device 404 are executed by the CPU 401.

The auxiliary storage device 404 stores various programs, data groups collected by executing the various programs by the CPU 401, and calculated analysis result data, and generated models. The data storage part 114, the analysis result storage part 115 and the model storage part 116 are implemented in the auxiliary storage device 404.

The operation device 405 is an input device used when the administrator of the data processing apparatus 110 inputs various instructions to the data processing apparatus 110. The display device 406 is a display device which displays internal information of the data processing apparatus 110.

The I/F device 407 is a connection device that connects to the network 150 and communicates with the terminals 121, 131, and 141 of the respective business offices 120, 130, and 140.

The drive device 408 is a device for setting a recording medium 410. The recording medium 410 used herein includes a medium for optically, electrically, or magnetically recording information, such as a CD-ROM, a flexible disc, a magneto-optical disc or the like. In addition, the recording medium 410 may include, for example, a semiconductor memory that electrically records information, such as, ROM or flash memory.

In addition, the various programs to be installed in the auxiliary storage device 404 are installed, for example, by setting a distributed recording medium 410 into the drive device 408 and reading out, by the drive device 408, the various programs recorded in the recording medium 410. Alternatively, the various programs to be installed in the auxiliary storage device 404 may be installed by being downloaded via the network 150.

### <Functional Configuration of Data Analysis Part of Data Processing Device>

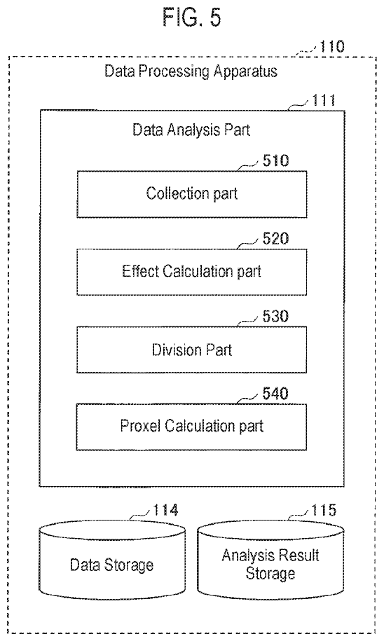

Next, the functional configuration of the data analysis part 111 of the data processing apparatus 110 will be described. FIG. 5 is a view illustrating an exemplary functional configuration of the data analysis part. As illustrated in FIG. 5, the data analysis part 111 includes a collection part 510, an effect calculation part 520, a division part 530, and a Proxel calculation part 540.

The collection part 510 collects the data group (e.g., the data group 201 or the like) from each of the terminals 121, 131, and 141 of the business offices 120, 130, and 140 via the network 150.

The effect calculation part 520 calculates an effect for each collected data group. The effect calculation part 520 acquires, for each collected data group, data indicating a state before executing a respective step of a respective process and data indicating a state after executing the respective step of the respective process, and calculates a change in the state before and after the execution as an effect using these data. In addition, the effect calculation part 520 stores the calculated effect in the data storage part 114 as a data group together with the setting data, the output data, the measurement data, and the experimental data.

The division part 530 reads out each of a plurality of data groups stored in the data storage part 114 to analyze distribution in a feature space. When the type of data included in each data group is K, the division part 530 analyzes the distribution of the data group in a K-dimensional feature space.

Specifically, the division part 530 groups a plurality of data groups that have the same effect with respect to the plurality of read data groups. Further, the division part 530 divides the K-dimensional feature space such that the data groups distributed in the feature space are classified into groups.

The Proxel calculation part 540 calculates the Proxel by calculating the range (specific data specified by a group) of each of the K types of data in each region of the K-dimensional feature space divided by the division part 530, and stores the calculated Proxel in the analysis result storage part 115 as the analysis result data.

### <Specific Example of Processing of Each Part of Data Analysis Part>

Next, among the respective parts (the collection part 510, the effect calculation part 520, the division part 530, and the Proxel calculation part 540) of the data analysis part 111, a specific example of the processing of the effect calculation part 520, the division part 530, and the Proxel calculation part 540 will be described.

### (1) Specific Example of Processing of Effect Calculation Part

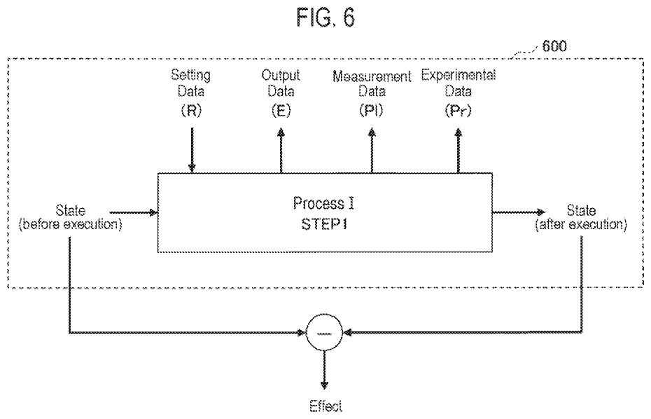

First, a specific example of the processing of the effect calculation part 520 will be described. FIG. 6 is a diagram illustrating a specific example of the processing of the effect calculation part 520.

As illustrated in FIG. 6, a relationship between a predetermined step of a predetermined semiconductor manufacturing process (process name=“PROCESS”, step name=“STEP”) and a data group may be schematically represented as represented by a dotted line 600.

That is, when the semiconductor manufacturing apparatus in which the setting data is set executes the predetermined step of the predetermined semiconductor manufacturing process, a state before the execution (any one of the attribute of the processing target, the state of the semiconductor manufacturing apparatus, and the internal atmosphere of the semiconductor manufacturing apparatus before the execution) is changed after the execution. Then, an execution situation of the semiconductor manufacturing process at this time may be specified by the setting data, the output data, the measurement data, and the experimental data.

That is, under the execution situation specified by the setting data, the output data, the measurement data, and the experimental data, the effect in the predetermined step of the predetermined semiconductor manufacturing process may be represented by a difference between the following:
Data indicating state before execution, and
Data indicating state after execution

Therefore, the effect calculation part 520 acquires the data indicating the state before execution and the data indicating the state after execution, corresponding to each data group for each step of each process. Then, the effect calculation part 520 calculates the effect corresponding to each execution situation in the respective step of the respective process by calculating a difference between the two data. In addition, the effect calculation part 520 stores the calculated effect in the data storage part 114 as a data group in associate with the setting data, the output data, the measurement data, and the experimental data.

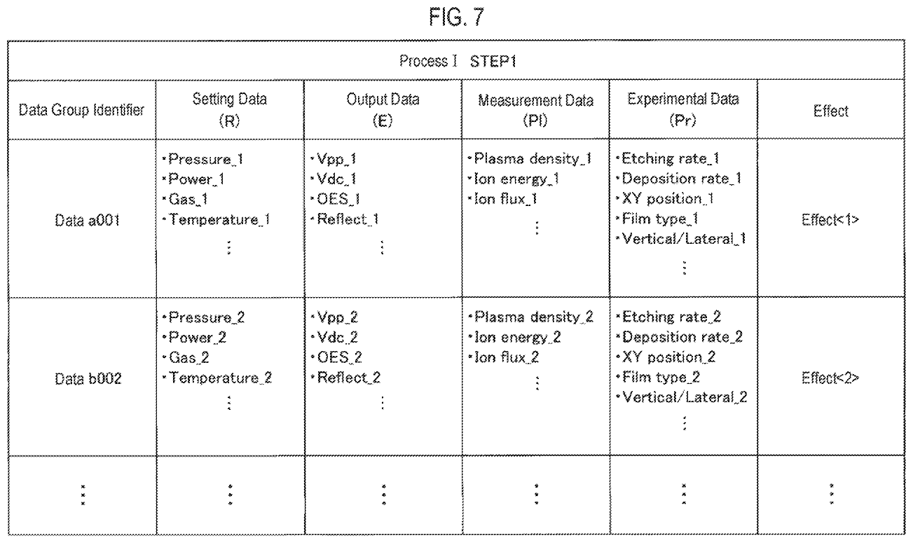

FIG. 7 is a view illustrating an example of a data group stored in the data storage part, which is stored in the data storage part 114 by the effect calculation part 520 with respect to a step having the step name “STEP 1” of a semiconductor manufacturing process having the process name “PROCESS I”.

As illustrated in FIG. 7, the data group stored in the data storage part 114 by the effect calculation part 520 includes “Data Group Identifier”, “Setting Data (R)”, “Output Data (E)”, “Measurement Data (Pl)”, “Experimental Data (Pr)”, and “Effect” as information items.

The “Data Group Identifier” is an identifier for identifying each data group. In FIG. 7, a data group identifier “Data a001” is, for example, a data group including a data group collected from the business office 120 (business office name=“Business Office A”) and an effect. In addition, a data group identifier “Data a002” is, for example, a data group including a data group collected from the business office 130 (business office name=“Business Office B”) and an effect.

In the information items from the Setting Data (R) to the Experimental Data (Pr), data groups excluding the initial data (I) and the target data (Pf) among the data groups (see FIG. 2) collected from each of the business offices 120, 130, and 140 are stored.

In the information item of “Effect”, the effects calculated by the effect calculation part 520 are stored. According to the example of FIG. 7, in the case of the step having the step name “STEP 1” of the semiconductor manufacturing process having the process name “PROCESS I”, “Effect <1>” is obtained under the execution situation specified by the setting data or the like associated with the data group identifier “Data a001”. Similarly, in the case of the step having the step name “STEP 1” of the semiconductor manufacturing process having the process name “PROCESS I” “Effect <2>” is obtained under the execution situation specified by the setting data or the like associated with the data group identifier “Data a002”.

### (2) Specific Example of Processing of Division Part

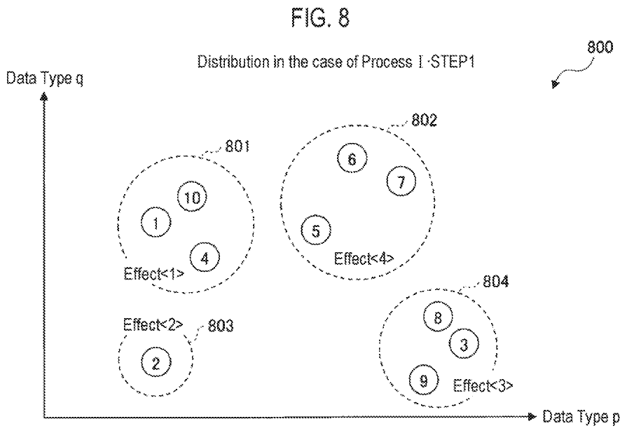

Next, a specific example of the processing of the division part 530 will be described. FIG. 8 is a view illustrating a specific example of the processing of the division part.

As illustrated in FIG. 8, the division part 530 reads out the plurality of data groups stored in the data storage part 114 for each process and for each step, and plots the read data groups in a feature space 800. In FIG. 8, each solid line circle mark in which a numerical value is shown indicates one of the plurality of read data groups, and numerical values shown in the solid line circle mark indicates a data group identifier of the respective data group.

In the example of FIG. 8, for the sake of simplification in description, the feature space 800 is illustrated as a two-dimensional configuration (that is, a state in which two types of data (data type p and data type q) included in a data group are plotted).

In FIG. 8, dotted line circle marks surrounding the outside of solid line circle marks indicate how data groups that achieve the same effect are grouped. That is, data groups identified by the data group identifiers described in the solid line circle marks included in each dotted line circle mark represent the data groups having the same effect in the steps having the step name “STEP1” of the semiconductor manufacturing process having the process name “PROCESS I”.

For example, the dotted line circle mark 801 includes data groups having the data group identifiers “Data a001”, “Data a004”, and “Data a010”. The solid line circle marks in which these data group identifiers are respectively described are distributed at positions close to each other in the feature space 800, but do not completely overlap each other. That is, the data groups identified by the respective data group identifiers are similar to each other, but do not completely coincide with each other.

Meanwhile, these data groups are data groups in all of which the Effect <1> is capable of being obtained when the step having the step name “STEP 1” of the semiconductor manufacturing process having the process name “PROCESS I” is executed. In other words, the plurality of data groups grouped by the dotted line circle mark 801 in the feature space 800 are data groups in which the Effect <1> is obtained even if STEP 1 of PROCESS I is executed under any of the data groups.

Similarly, in FIG. 8, a dotted line circle mark 802 includes data group identifiers “Data a005”, “Data a006”, and “Data a007”. All the data groups identified by the data group identifiers described in respective solid line circle marks included in the dotted line circle mark 802 are data groups in which the Effect <4> is obtained when STEP 1 of PROCESS I is performed based on the respective data groups.

Similarly, in FIG. 8, a dotted line circle mark 803 includes a data group identifier “Data a002”. The data group identified by the data group identifier described in the solid line circle mark included in the dotted line circle mark 803 is a data group in which the Effect <2> is obtained when STEP 1 of PROCESS I is performed based on the respective data group.

Similarly, in FIG. 8, a dotted line circle mark 804 includes data group identifiers “Data a003”, “Data a008”, and “Data a009”. All the data groups identified by the data group identifiers described in respective solid line circle marks included in the dotted line circle mark 804 are data groups in which the Effect <3> is obtained when STEP 1 of PROCESS I is performed based on the respective data groups.

As described above, the division part 530 divides the feature space such that each data group distributed in the feature space is classified for each group. Further, the division part 530 divides the feature space by performing clustering processing with respect to each data group distributed in the K-dimensional feature space using “Effect” as a division index.

### (3) Specific Example of Processing of Proxel Calculation Part

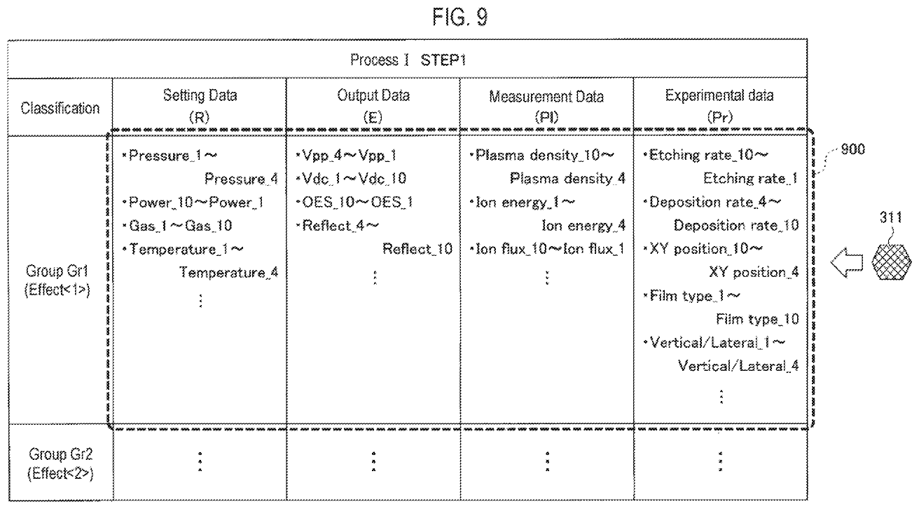

Next, a specific example of the processing performed by the Proxel calculation part 540 will be described. As described above, the Proxel calculation part 540 calculates the Proxel by calculating the range of each data (specific data specified by a group) of each region of the feature space divided by the division part 530. FIG. 9 is a view illustrating an example of Proxel calculated by the Proxel calculation part 540.

As illustrated in FIG. 9, the Proxel calculation part 540 calculates the range of each data in each region in the feature space by calculating the minimum value and the maximum value for each data included in each of the data groups grouped into the same group by the division part 530.

The example of FIG. 9 illustrates that a data group that provides the same effect as the Effect <1> is grouped by the division part 530 into a group having the group name “group Gr1”. In addition, in the example of FIG. 9, among the data included in the data group grouped into the group having the group name “Group Gr1”, “Pressure” of the setting data is indicated as follows:
Minimum value=“Pressure_1”
Maximum value=“Pressure_4”

The range of each data in the region of the feature space, in which the data group grouped into the group having the group name “Group Gr1” is distributed, may be indicated, specifically, by a dotted line 900. In addition, the range of each data represented by the dotted line 900 is assumed to be the Proxel 311 described in FIG. 3.

### <Flow of Proxel Calculation Processing>

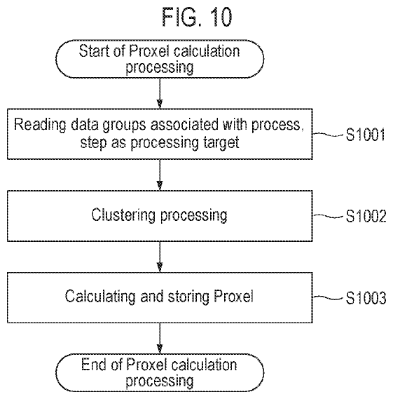

Next, the flow of the Proxel calculation processing by the division part 530 and the Proxel calculation part 540 will be described. FIG. 10 is a first flowchart illustrating the flow of the Proxel calculation processing by the division part and the Proxel calculation part.

In step S1001, the division part 530 reads out, from the data storage part 114, a data group associated with a predetermined step of a predetermined process.

In step S1002, the division part 530 divides the feature space by performing the clustering processing on each data group such that data groups having the same effect are classified into the same group.

In step S1003, the Proxel calculation part 540 calculates the Proxel by calculating the range of each data (specific data specifying each group) in each region of the feature space divided by the division part 530. In addition, the Proxel calculation part 540 stores the calculated Proxel in the analysis result storage part 115 as analysis result data.

### <Advantages of Proxel Calculation>

Next, advantages obtained when the Proxel calculation part 540 calculates the Proxel will be described.

### (1) Improvement in Ease of Data Handling

One of the advantages obtained when the Proxel calculation part 540 calculates Proxel may be, for example, the improvement in ease of handling the plurality of data groups collected from the business offices 120, 130, and 140.

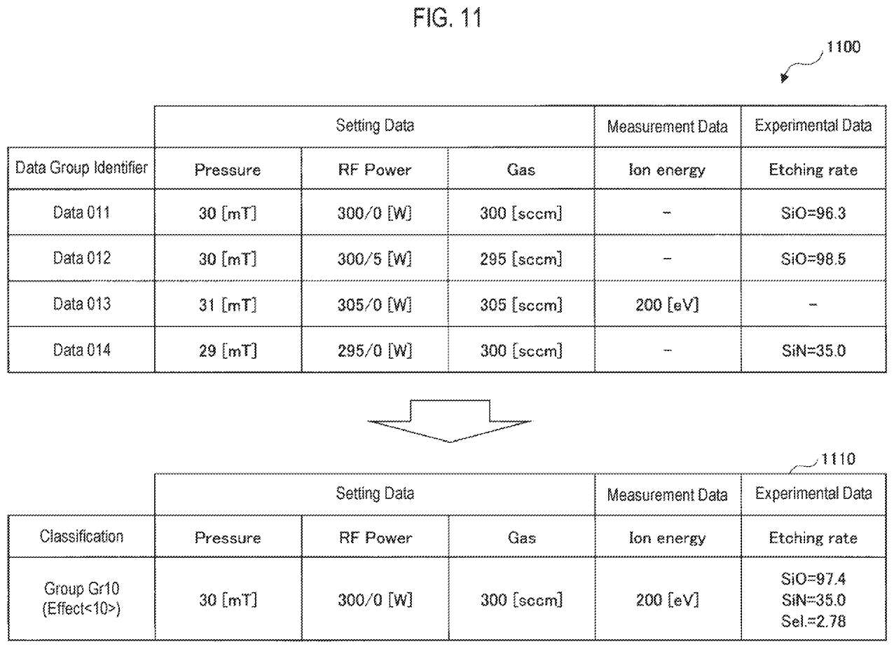

FIG. 11 is a first view for explaining an advantage of calculating the Proxel. In FIG. 11, each of a plurality of data groups 1100 is an example of a plurality of data groups collected from each of the business offices 120, 130, and 140. It is assumed that all of them are data groups that capable of providing the same effect. In FIG. 11, for the sake of simplification in description, five types of data are included in each data group.

Among the plurality of data groups 1100, some cells of “Ion Energy” in “Measurement Data” and “Etching Rate” in “Experimental Data” are blank because the respective business offices do not have a measurement device for measuring the respective data or an experimental data measurement device.

Meanwhile, in FIG. 11, a Proxel 1110 is an example of Proxel calculated by the Proxel calculation part 540 based on the plurality of data groups 1100.

By calculating the Proxel 1110, it becomes possible to handle a plurality of data groups that are capable of obtaining the same effect (“Effect <10>”), as one data group. By calculating the Proxel 1110 in this way, it is possible to interpolate an incomplete data group including a blank and handle the incomplete data group as one highly versatile data group including no blank. That is, by calculating the Proxel, it is possible to implement highly versatile data processing.

### (2) Making Densities of Data Groups Uniform

One of the advantages obtained when the Proxel calculation part 540 calculates the Proxel is that the calculation is less susceptible to a variation in the density of the plurality of data groups collected from the business offices 120, 130, and 140. That is, it is possible to make the densities of data groups in the feature space uniform.

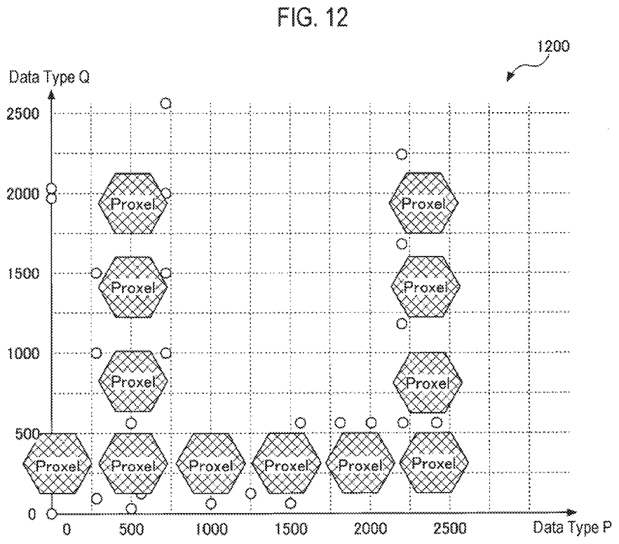

FIG. 12 is a second view for explaining an advantage of calculating the Proxel. In FIG. 12, the horizontal axis represents data type P (here, “HF Power”), and the vertical axis represents data type Q (here, “LF Power”).

In a feature space 1200 illustrated in FIG. 12, white circles represent distributions of respective data groups, and regular hexagons represent Proxels. As illustrated in FIG. 12, distribution densities of the plurality of data groups collected from the business offices 120, 130, and 140 in the feature space 1200 vary. In contrast, it is possible to uniformly arrange Proxels in the feature space 1200.

As described above, by calculating the Proxels, it is possible to evenly handle data groups in various regions of the feature space 1200. Thus, for example, when mechanical learning is performed using Proxels, it is possible to suppress the influence of variation in data groups. That is, by calculating the Proxels, it is possible to implement highly versatile data processing.

### <Functional Configuration of Model Generation Part of Data Processing Device>

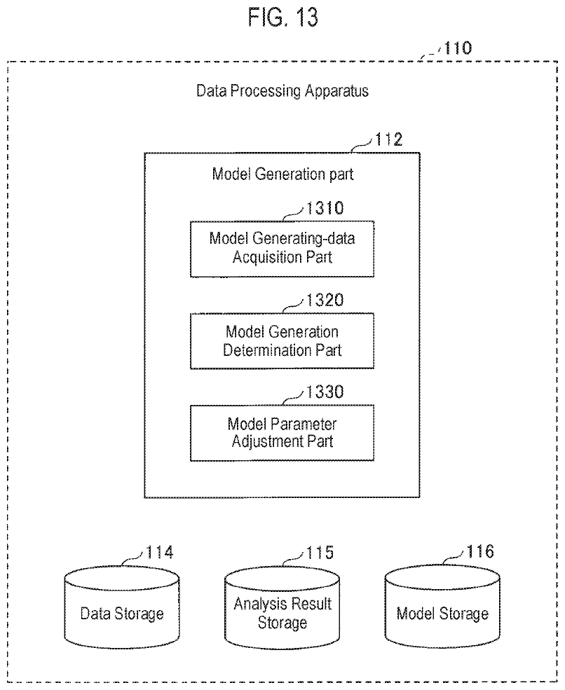

Next, descriptions will be made on a functional configuration of the model generation part 112 of the data processing apparatus 110. FIG. 13 is a view illustrating an example of the functional configuration of the model generation part. As illustrated in FIG. 13, the model generation part 112 includes a model generating-data acquisition part 1310, a model generation determination part 1320, and a model parameter adjustment part 1330.

The model generating-data acquisition part 1310 sequentially reads the plurality of Proxels stored in the analysis result storage part 115, and reads a plurality of data groups classified into each of the plurality of read Proxels, from the data storage part 114. The model generating-data acquisition part 1310 notifies the model generation determination part 1320 of the plurality of data groups classified into each Proxel, on the basis of Proxel.

The model generation determination part 1320 determines whether to generate, for each of the plurality of data groups notified on the basis of Proxel, a new model corresponding to a respective Proxel.

Specifically, the model generation determination part 1320 obtains a prediction result with respect to each of the plurality of data groups in the notification, based on data included in the data group, other data pieces, knowledge and the like, by predicting, for example.
a state of the semiconductor manufacturing apparatus when a respective step is executed (for example, an amount of a deposition film within the chamber, a degree of wear of internal components constituting the chamber and the like),
an internal atmosphere of the semiconductor manufacturing apparatus when the respective step is executed, and
a time-dependent change in a processing target when the respective step is executed (for example, an aperture ratio or the like).

The model generation determination part 1320 obtains a determination result by determining the premise for execution of the respective step, namely, for example,
a position within the semiconductor manufacturing apparatus, at which a state change is measured (for example, the edge, the center or the like), and
the type of the semiconductor manufacturing apparatus (for example, different hardwares, or different objects in the same hardware).

Then, the model generation determination part 1320 determines whether to generate a new model corresponding to the respective Proxel, by using the above “prediction result” and “determination result”, as determination indices. For example, when the prediction result and the determination result are substantially the same as prediction results and determination results of other data groups classified into the respective Proxel, the model generation determination part 1320 does not generate the new model. Meanwhile, when the prediction result and the determination result are different from the prediction results and the determination results of other data groups classified into the respective Proxel, the model generation determination part 1320 generates the new model.

It is assumed that the model generated by the model generation determination part 1320 has a plurality of simulators configured in a nested structure. The plurality of simulators includes, for example,
a processing space (chamber) simulator,
an electromagnetic field simulator or a thermo-fluid simulator,
a plasma simulator or a dissociation simulator,
a shape simulator,
a molecular dynamics (MD) simulator, and
a quantum chemical reaction simulator or materials informatics.

The model parameter adjustment part 1330 adjusts model parameters with respect to the model generated by the model generation determination part 1320. The model parameter adjustment part 1330 adjusts model parameters such that when a simulation processing is performed by inputting
the data group, and
attributes of the respective processing target (the attributes of the processing target before the execution when the respective step is executed)

into the generated model, the output coincides with
the “effect” included in the respective data group.

Accordingly, for each Proxel, the model parameter adjustment part 1330 may adjust parameters of a plurality of models generated according to
the prediction results, and
the determination results.

The model parameter adjustment part 1330 stores the models whose parameters are adjusted, for each Proxel, in the model storage part 116, in association with the prediction results and the determination results.

### <Specific Example of Processing of Each Part of Model Generation Part>

Next, descriptions will be made on specific examples of processings of respective parts (the model generating-data acquisition part 1310, the model generation determination part 1320, and the model parameter adjustment part 1330) of the model generation part 112.

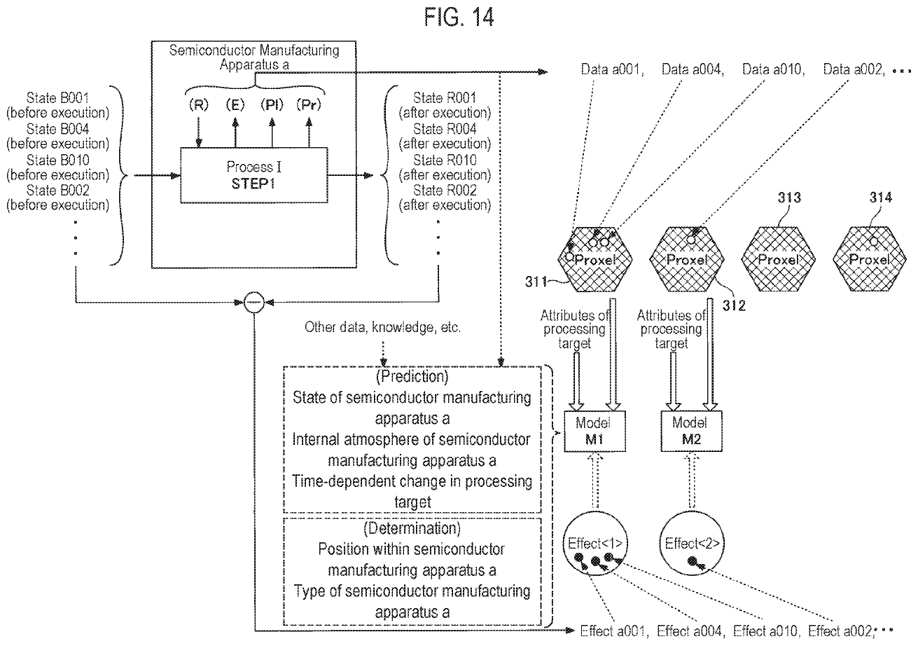

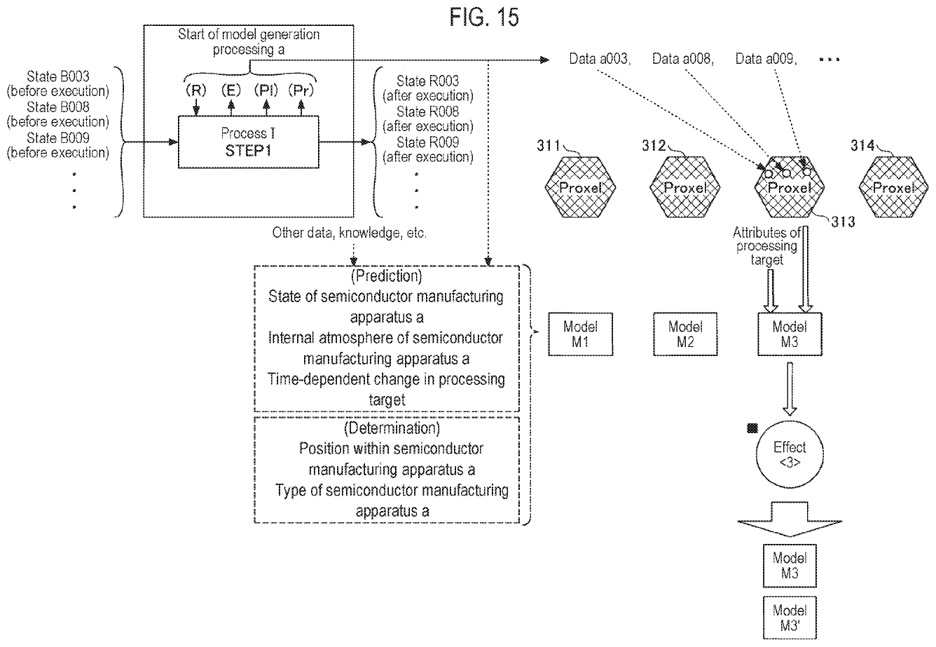

FIG. 14 and FIG. 15 are first and second views illustrating specific examples of the processing of the model generation part. The example of FIG. 14 illustrates that through execution of the step (step name=“STEP1”) of the process (process name=“process I”) by the semiconductor manufacturing apparatus a,
data “state B001 (before execution)” indicating the state before the execution is changed to data “state R001 (after execution)” indicating the state after the execution, and
a data group having the data group identifier=“data a001” is collected.

Likewise, the example of FIG. 14 illustrates that through execution of the step (step name=“STEP1”) of the process (step name=“process I”) by the semiconductor manufacturing apparatus a,
data “state B004 (before execution)” indicating the state before the execution is changed to data “state R004 (after execution)” indicating the state after the execution, and
a data group having the data group identifier=“data a004” is collected.

Hereinafter, in the execution of the step (step name=“STEP1”) of the process (process name=“process I”) by the semiconductor manufacturing apparatus a, a relationship between the data indicating the state before the execution and the data indicating the state after the execution, and a relationship with the collected data group are the same.

The example of FIG. 14 illustrates that the data groups having the data group identifiers=“data a001”, “data a004”, and “data a010” are classified into the Proxel 311, and illustrates that the data group having the data group identifier=“data a002” is classified into the Proxel 312.

The example of FIG. 14 illustrates that the data groups having the data group identifiers=“data a001”, “data a004”, “data a010”, and “data a002” include effects “effect a001”, “effect a004”, “effect a010”, and “effect a002”, respectively. The example of FIG. 14 illustrates that the “effect a001”, the “effect a004”, and the “effect a010” are included in the “effect <1>”, and the “effect a002” is included in the “effect <2>”.

Based on such a premise, the model generating-data acquisition part 1310 reads the plurality of data groups (data groups having the data group identifiers=“data a001”, “data a004” and “data a010”, respectively) classified into, for example, the Proxel 311.

Then, the model generation determination part 1320 determines whether to generate a new model corresponding to the Proxel 311, for the plurality of read data groups (data groups having the data group identifiers=“data a001”, “data a004”, and “data a010”, respectively).

Here, it is assumed that the model generation determination part 1320 determines that as a result of predicting the state of the semiconductor manufacturing apparatus a, the internal atmosphere of the semiconductor manufacturing apparatus a, and the time-dependent change in the processing target when the step (step name=“STEP1”) of the process (process name=“process I”) is executed,
a prediction result predicted based on data included in the data group having the data group identifier=“data a001”, other data pieces, knowledge and the like,
a prediction result predicted based on data included in the data group having the data group identifier=“data a004”, other data pieces, knowledge and the like, and
a prediction result predicted based on data included in the data group having the data group identifier=“data a010”, other data pieces, knowledge and the like are substantially equal to each other.

It is assumed that the model generation determination part 1320 determines that determination results obtained by determining the premises for execution of the step (step name=“STEP1”) of the process (process name=“process I”) are equal to each other.

In the case of these prediction results and determination results, the model generation determination part 1320 generates one model (a model having a model name=“Model M1”) for the data groups having the data group identifiers=“data a001”, “data a004”, and “data a010”, respectively.

Then, the model parameter adjustment part 1330 adjusts model parameters such that when a simulation processing is performed by inputting
the data group having the data group identifier=“data a001”, and
attributes of the respective processing target (the attributes of the processing target before the execution when the step (step name=“STEP1” of process name=“Process I”) is executed)

into the model (model name=“Model M1”), the output coincides with
the “effect a001”,

when a simulation processing is performed by inputting
the data group having the data group identifier=“data a004”, and
attributes of the respective processing target (the attributes of the processing target before the execution when the step (step name=“STEP1” of process name=“Process I”) is executed), into the model (model name=“Model M1”), the output coincides with
the “effect a004”, and

when a simulation processing is performed by inputting
the data group having the data group identifier=“data a010”, and
attributes of the respective processing target (the attributes of the processing target before the execution when the step (step name=“STEP1” of process name=“Process I”) is executed), into the model (model name=“Model M1”), the output coincides with
the “effect a010”.

The model parameter adjustment part 1330 also adjusts model parameters for a model having model name=“Model M2” in a manner analogous to the above method.

Meanwhile, the example of FIG. 15 illustrates a case where after generating a model for the Proxel 313, the model generation determination part 1320 determines to further generate a new model.

Specifically, the example of FIG. 15 illustrates a case where a model having a model name=“Model M3” is generated based on data groups having data group identifiers=“data a003” and “data a008” respectively. The example of FIG. 15 illustrates a case where subsequently, it is determined to further generate a new model corresponding to a data group having a data group identifier=“data a009”.

Here, it is assumed that, instead of generating a new model, the model generation determination part 1320 performs a simulation processing by inputting, into the model having the model name=“Model M3”,
the data group having the data group identifier=“data a009”, and
attributes of the respective processing target (the attributes of the processing target before the execution when the step (step name=“STEP1” of process name=“Process 1”) is executed).

In this case, as indicated by the black square in the example of FIG. 15, when the simulation processing is performed, the output is not included in the effect <3>, and deviates from the effect <3>.

In order to avoid such a situation, the model generation determination part 1320 determines whether to further generate a new model corresponding to the data group having the data group identifier=“data a009”, by using the prediction result and the determination result as determination indices.

The example of FIG. 15 illustrates a state where the model generation determination part 1320 determines to generate a new model corresponding to the Proxel 313, and generates a model having the model name=“Model M3”.

In this case, the model parameter adjustment part 1330 adjusts model parameters of the model having the model name=“Model M3’” such that when a simulation processing is performed by inputting
the data group having the data group identifier=“data a009”, and
attributes of the respective processing target (the attributes of a processing target before the execution when the step (step name=“STEP1” of process name=“Process I”) is executed), into the model having the model name=“Model M3’”, the output coincides with
the “effect a009” (not illustrated).

### <Flow of Model Generating Process>

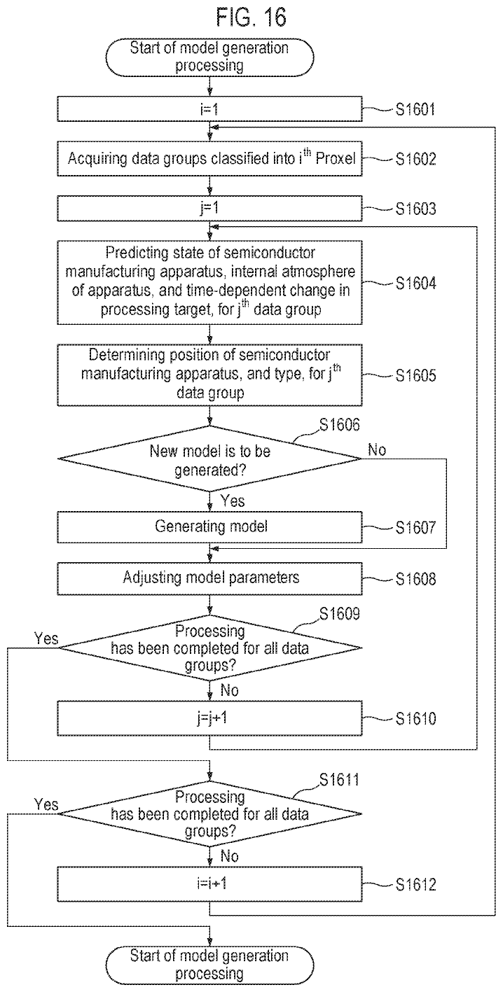

Next, a flow of the model generating process performed by the model generation part 112 will be described. FIG. 16 is a flowchart illustrating the flow of the model generating process performed by the model generation part.

In step S1601, the model generating-data acquisition part 1310 inputs “1” to a counter i that counts the number of Proxels.

In step S1602, the model generating-data acquisition part 1310 reads an ith Proxel stored in the analysis result storage part 115, and reads a plurality of data groups classified into the ith Proxel from the data storage part 114.

In step S1603, the model generating-data acquisition part 1310 inputs “1” to a counter j that counts the number of the read data groups.

In step S1604, the model generation determination part 1320 predicts a state of the semiconductor manufacturing apparatus, an internal atmosphere of the semiconductor manufacturing apparatus, and a time-dependent change in a processing target when a respective step is executed, based on data included in the jth data group, other data pieces, knowledge and the like.

In step S1605, the model generation determination part 1320 determines the premise for execution of the respective step, that is, a position within the semiconductor manufacturing apparatus, at which a state change is measured, and the type of the semiconductor manufacturing apparatus.

In step S1606, the model generation determination part 1320 determines whether to generate a new model corresponding to the jth data group, by using a prediction result and a determination result as determination indices.

When it is determined to generate a new model in step S1606 (“YES” in step S1606), the process proceeds to step S1607.

In step S1607, the model generation determination part 1320 generates the new model corresponding to the jth data group, and the process proceeds to step S1608.

Meanwhile, when it is determined not to generate the new model in step S1606 (“NO” in step S1606), the process directly proceeds to step S1608.

When the new model is generated in step S1607, in step S1608, the model parameter adjustment part 1330 performs a simulation processing by inputting the jth data group, and attributes of the respective processing target, into the new model. The model parameter adjustment part 1330 adjusts model parameters of the new model such that when the simulation processing is performed, the output coincides with the “effect” included in the jth data group.

On the other hand, when the new model is not generated, the model parameter adjustment part 1330 performs a simulation processing by inputting the jth data group, and attributes of the respective processing target, into the previously-generated model. The model parameter adjustment part 1330 re-adjusts model parameters of the previously-generated model such that when the simulation processing is performed, the output coincides with the “effect” included in the jth data group.

In step S1609, the model generation determination part 1320 determines whether the processing of the series of steps S1604 to S1608 has been executed for all the data groups read in step S1602.

When in step S1609, it is determined that there is a data group for which the processing has not been executed yet (“NO” in step S1609), the process proceeds to step S1610. In step S1610, the counter j is incremented by the model generation determination part 1320, and the process returns to step S1604.

Meanwhile, when in step S1609, it is determined that the processing has been executed for all the data groups (“YES” in step S1609), the process proceeds to step S1611.

In step S1611, the model generating-data acquisition part 1310 determines whether the processing of the series of steps S1602 to S1610 has been executed for all Proxels.

When in step S1611, it is determined that there is a Proxel for which the processing has not been executed yet (“NO” in step S1611), the process proceeds to step S1612. In step S1612, the counter I is incremented by the model generating-data acquisition part 1310, and the process returns to step S1602.

Meanwhile, when in step S1611, it is determined that the processing of the series of steps S1602 to S1610 has been executed for all Proxels, the model generating process ends.

### <Functional Configuration of Estimation Part>

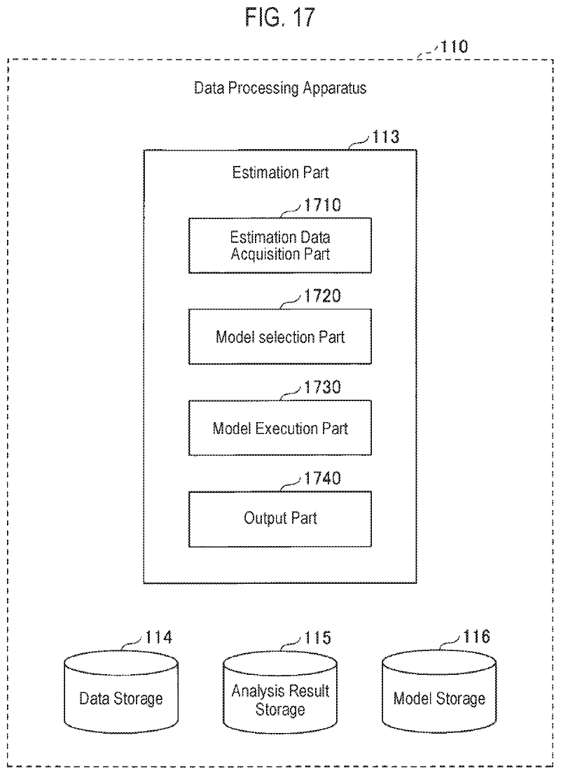

Next, descriptions will be made on a functional configuration of the estimation part 113 of the data processing apparatus 110. FIG. 17 is a view illustrating an example of the functional configuration of the estimation part. As illustrated in FIG. 17, the estimation part 113 includes an estimating-data acquisition part 1710, a model selection part 1720, a model execution part 1730, and an output part 1740.

The estimating-data acquisition part 1710 reads a data group (a new data group) as a target for which a simulation processing is to be performed, from the data storage part 114. The estimating-data acquisition part 1710 determines into which Proxel the read data group is classified, with reference to Proxels stored in the analysis result storage part 115.

The model selection part 1720 is an example of a selection part. The model selection part 1720 predicts a state of the semiconductor manufacturing apparatus, an internal atmosphere of the semiconductor manufacturing apparatus, and a time-dependent change in a processing target when a respective step is executed, based on data included in the new data group, other data pieces, knowledge and the like.

The model selection part 1720 determines the premise for execution of the respective step, that is, a position within the semiconductor manufacturing apparatus, at which a state change is measured, and the type of the semiconductor manufacturing apparatus.

The model selection part 1720 selects one model based on selection indices, among a plurality of models stored in the model storage part 116, that is, models stored in association with the Proxel into which the new data group is classified. Specifically, the model selection part 1720 selects a model associated with the same prediction result and the same determination result, among models associated with the Proxel into which the new data group is classified.

The model execution part 1730 is an example of an execution part. The model execution part 1730 performs a simulation processing by inputting the new data group, and attributes of the respective processing target, into the one model selected by the model selection part 1720.

The output part 1740 outputs the effect estimated by the simulation processing performed by the model execution part 1730.

### <Specific Example of Processing of Each Part of Estimation Part>

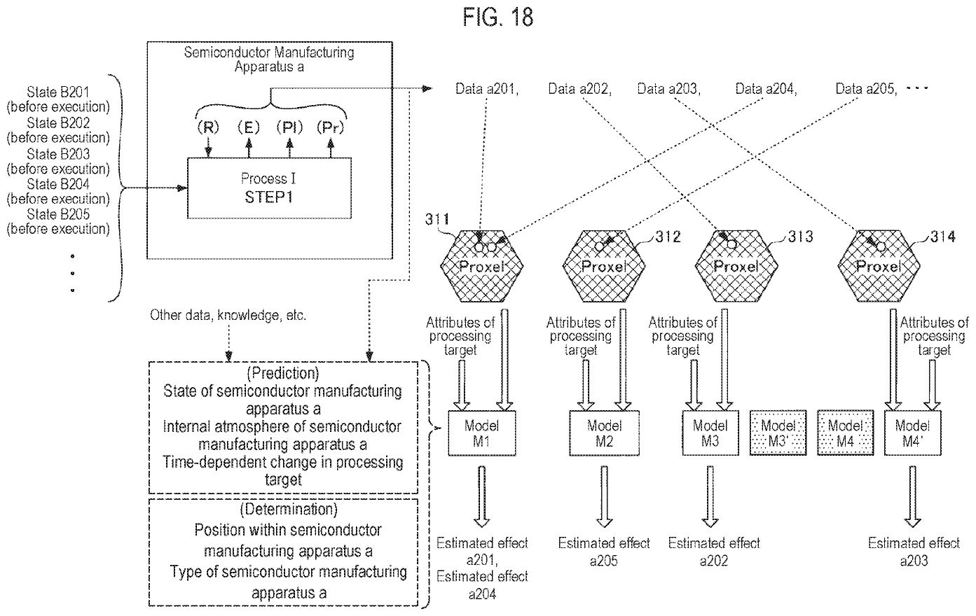

Next, descriptions will be made on specific examples of processings of respective parts (the estimating-data acquisition part 1710, the model selection part 1720, the model execution part 1730, and the output part 1740) of the estimation part 113. FIG. 18 is a view illustrating the specific example of the processing of the estimation part.

The example of FIG. 18 illustrates that when the step (step name=“STEP1”) of the process (process name=“Process I”) is executed by the semiconductor manufacturing apparatus a, data indicating the state before the execution is “state B201 (before execution)”, and
a data group having a data group identifier=“data a201” is newly collected after the execution.

Likewise, the example of FIG. 18 illustrates that when the step (step name=“STEP1”) of the process (process name=“Process 1”) is executed by the semiconductor manufacturing apparatus a, data indicating the state before the execution is “state B202 (before execution)”, and
a data group having a data group identifier=“data a202” is newly collected after the execution.

Hereinafter, in the execution of the step (step name=“STEP1”) of the process (process name=“Process I”) by the semiconductor manufacturing apparatus a, a relationship between the data indicating the state before the execution, and the data group newly collected after the execution are the same as above.

Based on such a premise, the example of FIG. 18 illustrates that the estimating-data acquisition part 1710 reads data groups having the data group identifiers=“data a201” to “data a205”, respectively. The example of FIG. 18 illustrates that the estimating-data acquisition part 1710 classifies the data groups having the data group identifiers=“data a201” and “data a204”, respectively, into the Proxel 311, and also illustrates that the estimating-data acquisition part 1710 classifies the data groups having the data group identifiers=“data a202”, “data a203”, and “data a205” into the Proxels 313, 314, and 312, respectively.

Here, in the example of FIG. 18, one model is associated with each of the Proxels 311 and 312. Thus, for example, the model execution part 1730 performs simulation processings by inputting, into the model having the model name=“Model M1”,
each of the data groups having the data group identifiers=“data a201”, and “data a204”, and
attributes of a respective processing target (the attributes of the processing target before the execution when a respective step is executed), and

by inputting, into the model having the model name=“Model M2”,
the data group having the data group identifier=“data a205”, and
attributes of the respective processing target (the attributes of the processing target before the execution when the respective step is executed),

thereby outputting an estimated effect a201, an estimated effect a204, and an estimated effect a205.

Meanwhile, two models are associated with each of the Proxels 313 and 314. Thus, the model selection part 1720 predicts
the state of the semiconductor manufacturing apparatus a,
the internal atmosphere of the semiconductor manufacturing apparatus a, and
the time-dependent change in the processing target

when the step (step name=“STEP1”) of the process (process name=“Process I”) is executed based on data included in the data group having the data group identifier=“data a202”, other data pieces, knowledge and the like. The model selection part 1720 determines the premise for execution of the step (step name=“STEP1”) of the process (process name=“Process 1”), that is, a position within the semiconductor manufacturing apparatus a, at which a state change is measured, and the type of the semiconductor manufacturing apparatus a.

The example of FIG. 18 illustrates a state where the model selection part 1720 selects the model having the model name=“Model M3” by using the prediction result and the determination result as selection indices, and the model execution part 1730 performs a simulation processing by inputting, into the model having the model name=“model M3”,
the data group having the data group identifier=“data a202”, and
attributes of the respective processing target (the attributes of the processing target before the execution when the respective step is executed), thereby outputting an estimated effect a202.

Likewise, the example of FIG. 18 illustrates a state where the model selection part 1720 selects a model having a model name=“Model M4” by using the prediction result and the determination result as selection indices, and the model execution part 1730 performs a simulation processing by inputting, into the model having the model name=“Model M4”,
the data group having the data group identifier=“data a203”, and
attributes of the respective processing target (the attributes of the processing target before the execution when the respective step is executed),

thereby outputting an estimated effect a203.

### <Flow of Estimating Process>

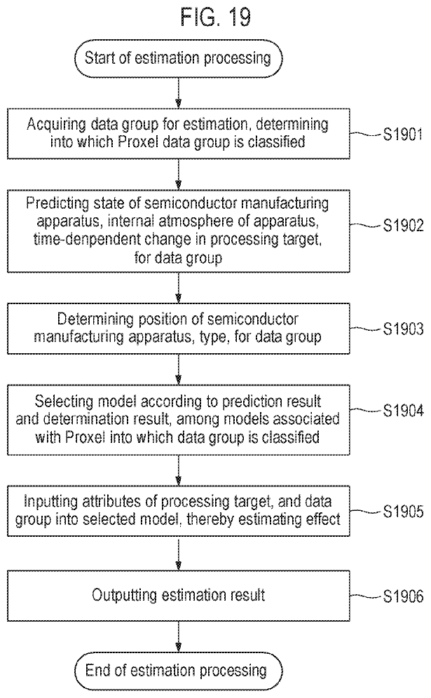

Next, descriptions will be made on a flow of the estimating process performed by the estimation part 113. FIG. 19 is a flowchart illustrating the flow of the estimating process performed by the estimation part.

In step S1901, the estimating-data acquisition part 1710 reads a new data group from the data storage part 114, and determines into which Proxel the read data group is classified.

In step S1902, the model selection part 1720 predicts a state of the semiconductor manufacturing apparatus, an internal atmosphere of the semiconductor manufacturing apparatus, and a time-dependent change in a processing target when a respective step is executed, based on data included in the read data group, other data pieces, knowledge and the like.

In step S1903, the model selection part 1720 determines the premise for execution of the respective step, that is, a position within the semiconductor manufacturing apparatus, at which a state change is measured, and the type of the semiconductor manufacturing apparatus.

In step S1904, the model selection part 1720 selects one model by using a prediction result and a determination result as selection indices, among models associated with the classified Proxel in step S1901.

In step S1905, the model execution part 1730 performs a simulation processing by inputting the read data group, and attributes of the respective processing target, into the one selected model, thereby estimating an effect.

In step S1906, the output part 1740 outputs the effect estimated by the simulation processing performed by the model execution part 1730.

### <Advantages in Performing Simulation Processing Using Model Per Proxel>

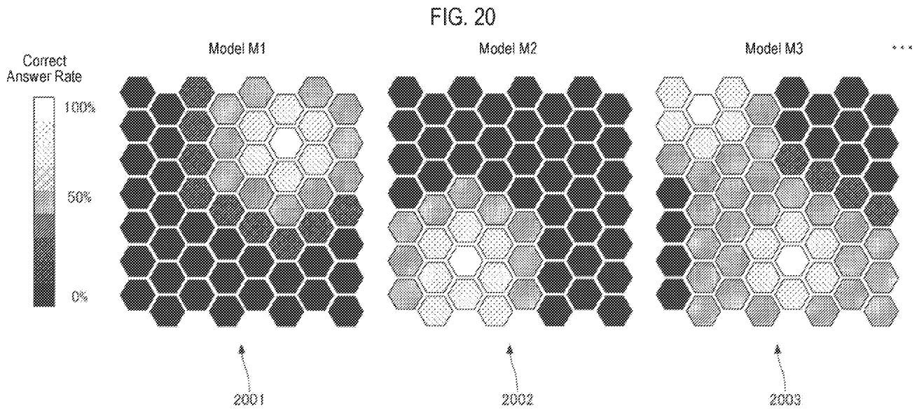

Next, descriptions will be made on advantages in a simulation processing performed by the estimation part 113, in which a model generated on the basis of Proxel by the model generation part 112 is used. FIG. 20 is a view illustrating an example of simulation accuracy in each model per Proxel.

In FIG. 20, reference numeral 2001 indicates a correct answer rate of each Proxel when data groups classified into each of a plurality of Proxels in a feature space are inputs, and a simulation processing is performed by using the model having the model name=“Model M1”. Likewise, reference numeral 2002 indicates a correct answer rate of each Proxel when data groups classified into each of the plurality of Proxels in the feature space are inputs, and a simulation processing is performed by using the model having the model name=“Model M2”. Likewise, reference numeral 2003 indicates a correct answer rate of each Proxel when data groups classified into each of the plurality of Proxels in the feature space are inputs, and a simulation processing is performed by using the model having the model name=“Model M3”. In FIG. 20, the shade of a color within each Proxel represents a correct answer rate of each Proxel. Dark colored portions indicate that the correct answer rate is low, and light colored portions indicate that the correct answer rate is high.

As illustrated in FIG. 20, there is no model that covers the entire feature space at a high correct answer rate, and each model has high correct answer rates in specific Proxels. The models are different from each other in Proxels with high correct answer rates.

Therefore, with the configuration of the estimation part 113 in which a simulation processing is performed by using a model according to each Proxel, the simulation accuracy can be improved as compared to that in the case where the entire feature space is covered by only one model.

### <Summary>

As is clear from the above description, in the data processing apparatus 110 according to the first embodiment,
a data group is collected in each step of each process, and an effect is calculated for each collected data group.
in the distribution of data groups in each feature space, the feature space is divided such that data groups from which the same effects are obtained are classified into the same group.
a Proxel that specifies each data range in each region of the divided feature space is calculated, and is stored as analysis result data.
by inputting data groups classified into each Proxel, models outputting effects corresponding to Proxels, respectively, are generated, and are stored in association with the Proxels, respectively.
when a new data group is acquired, a Proxel into which the respective new data group is classified is determined based on the analysis result data.
a simulation processing is performed on the respective new data group by using a model stored in association with the determined Proxel, thereby estimating an effect caused by execution of the respective step.

By performing the simulation processing using the model generated in association with each Proxel in this manner, the simulation accuracy can be improved as compared to that when the entire feature space is covered by only one model.

That is, according to the first embodiment, it is possible to provide a data processing apparatus, a data processing method, and a non-transitory computer-readable recording medium that stores a program therefor, which are capable of improving a simulation accuracy in a simulation processing of a manufacturing process.

### Second Embodiment

In the first embodiment described above, there has been described that the model generation determination part 1320 determines whether to generate a new model, by using a prediction result and a determination result as determination indices.

However, the determination indices by which the model generation determination part 1320 determines whether to generate the new model are not limited thereto. For example, as illustrated in FIG. 15, the model generation determination part 1320 may determine whether to generate a new model by performing a simulation processing by using a previously-generated model, and determining whether an estimated effect is included in a predetermined effect. That is, whether to generate a new model may be determined by using an error of the effect as a determination index.

Specifically, the model generation determination part 1320 determines to generate a new model when a difference between an effect estimated by performing a simulation processing, and a predetermined effect is large. The model generation determination part 1320 determines not to generate the new model when the difference between the effect estimated by performing the simulation processing, and the predetermined effect is small.

In this case, the model generation determination part 1320 is configured to obtain a prediction result and a determination result after determining to generate the new model.

In this manner, according to the second embodiment, it is possible to generate a proper model for each Proxel. As a result, according to the second embodiment, it is possible to provide a data processing apparatus, a data processing method, and a non-transitory computer-readable recording medium that stores a program therefor, which are capable of further improving a simulation accuracy in a simulation processing of a manufacturing process.

### Other Embodiments

In the first embodiment described above, there has been described that the model generation determination part 1320 generates a new model by using a prediction result and a determination result as determination indices. However, even if prediction results or determination results are different, when the effects may be expressed in a continuous pattern, a model may be expressed in a continuous pattern instead of generating a new model. That is, one model may be defined such that the respective model can be estimated over effects in a predetermined range.

In the above first and second embodiments, Proxels are calculated by calculating the range of each data of each region of the divided feature space. However, a method of calculating the Proxels is not limited thereto.

For example, when the regions of the divided feature space are significantly separated from each other in the space, a processing of modifying the regions may be performed such that the regions are adjacent to each other, and a process of calculating the range of each data in each of the modified regions may be further performed, thus calculating the Proxels. Accordingly, it is possible to reduce an empty region (a region where Proxels are not defined) in the feature space.

In the above first and second embodiments, the Proxels are calculated by calculating the range of each data in each region of the divided feature space, and the respective Proxels are stored as analysis result data in the analysis result storage part 115. However, the analysis result data stored in the analysis result storage part 115 is not limited to the Proxels. For example, representative data representing each region of the divided feature space (specific data specifying each group) may be stored as analysis result data.

In the above first and second embodiments, the data analysis program, the model generation program, and the estimation program are installed in the data processing apparatus 110, and the data analysis part 111, the model generation part 112, and the estimation part 113 are implemented in the data processing apparatus 110. However, these programs may be installed in, for example, the terminals 121, 131, and 141 of the respective business offices 120, 130, and 140. In this case, the data analysis part 111, the model generation part 112, and the estimation part 113 are implemented in the terminals 121, 131, and 141 of the respective business offices 120, 130, and 140.

In the above first and second embodiments, there have been described that when the model generation determination part 1320 determines whether to generate a new model, and when the model selection part 1720 selects a model to be used for a simulation processing,
the state of the semiconductor manufacturing apparatus when the respective step is executed,
the internal atmosphere of the semiconductor manufacturing apparatus when the respective step is executed, and
the time-dependent change in the processing target when the respective step is executed
   are predicted, and
the position within the semiconductor manufacturing apparatus, at which the state change is measured, and
the type of the semiconductor manufacturing apparatus
   are determined. However, contents predicted and determined by the model generation determination part 1320 and the model selection part 1720 are not limited thereto, and contents other than the exemplified contents may be predicted or determined.

In the above first and second embodiments, the case has been described where the Proxels are calculated for the data groups collected in the semiconductor manufacturing process. However, the data groups for calculating the Proxels are not limited to the data groups collected in the semiconductor manufacturing process. Even in a manufacturing process other than the semiconductor manufacturing process, for example, in a manufacturing process using a plasma-based apparatus, setting data is generally complicated. For this reason, it is possible to obtain the above-described advantages even when Proxels are calculated for data groups collected in the manufacturing process using the plasma-based apparatus.

The present disclosure is not limited to the configurations illustrated herein, such as a combination of a configuration or the like illustrated in the above embodiments with other elements. With respect to this point, a change can be made within a scope without deviating from the gist of the present disclosure, and the scope can be appropriately determined according to an application form thereof.

According to the present disclosure in some embodiments, it is possible to provide a data processing apparatus, a data processing method, and a non-transitory computer-readable recording medium that stores a program therefor, which are capable of improving a simulation accuracy in a simulation processing of a manufacturing process.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A data processing apparatus comprising:
a first storage part that stores an analysis result that specifies each of a plurality of regions of a feature space when the feature space is divided such that a distribution of each of a plurality of data groups associated with a predetermined step of a manufacturing process in the feature space is classified according to an effect calculated for each of the plurality of data groups in the predetermined step;
a second storage part that stores a plurality of models each of which outputs the effect corresponding to each of the plurality of regions, in association with each of the plurality of regions, when the plurality of data groups classified into each of the plurality of regions of the feature space are inputted; and
an execution part configured to perform a simulation processing by using, among the plurality of models, a model stored in association with one region when a new data group associated with the predetermined step is acquired and when the one region into which the acquired new data group is classified is determined based on the analysis result.

2. The data processing apparatus of claim 1, further comprising: a selection part configured to select one model among the plurality of models based on predetermined selection indices when the plurality of models are stored in association with the one region.

3. The data processing apparatus of claim 2, wherein the selection indices include a prediction result obtained by predicting any of a state of an apparatus in which the predetermined step is executed, an internal atmosphere of the apparatus in which the predetermined step is executed, and a time-dependent change in a processing target when the predetermined step is executed.

4. The data processing apparatus of claim 2, wherein the selection indices include a determination result obtained by determining any of a type of an apparatus in which the predetermined step is executed, and a position within the apparatus at which a state change is measured when the predetermined step is executed.

5. The data processing apparatus of claim 1, further comprising: a determination part configured to determine, when a new data group associated with the predetermined step is acquired, which of the plurality of regions in the feature space the acquired new data group is classified into, based on the analysis result.

6. A data processing method in a data processing apparatus,
wherein the data processing apparatus includes: a first storage part that stores an analysis result that specifies each of a plurality of regions of a feature space when the feature space is divided such that a distribution of each of a plurality of data groups associated with a predetermined step of a manufacturing process in the feature space, is classified according to an effect calculated for each of the plurality of data groups in the predetermined step; and a second storage part that stores a plurality of models each of which outputs the effect corresponding to each of the plurality of regions, in association with each of the plurality of regions, when the plurality of data groups classified into each of the plurality of regions of the feature space are inputted,
the method comprising:
executing a simulation processing by using, among the plurality of models, a model stored in association with one region when a new data group associated with the predetermined step is acquired and when the one region into which the acquired new data group is classified is determined based on the analysis result.

7. A non-transitory computer-readable recording medium storing a program that causes a computer of a data processing apparatus to execute a simulation processing,
wherein the data processing apparatus includes: a first storage part that stores an analysis result that specifies each of a plurality of regions of a feature space when the feature space is divided such that a distribution of each of a plurality of data groups associated with a predetermined step of a manufacturing process in the feature space, is classified according to an effect calculated for each of the plurality of data groups in the predetermined step; and a second storage part that stores a plurality of models each of which outputs the effect corresponding to each of the plurality of regions, in association with each of the plurality of regions, when the plurality of data groups classified into each of the plurality of regions of the feature space are inputted, and
wherein the simulation processing is performed using, among the plurality of models, a model stored in association with one region when a new data group associated with the predetermined step is acquired and when the one region into which the acquired new data group is classified is determined based on the analysis result.
